(19) United States
(12) Patent Application Publication
(10) Pub. No.: US 2010/0029869 A1
(43) Pub. Date: Feb. 4, 2010

(54) Catalyst components for the polymerization of olefins and catalysts therefrom obtained

(75) Inventors: Giampiero Morini, Padova (IT); Tiziano Dall'Occo, Ferrara (IT); Dario Liguori, Forino (IT); Joachim T.M. Pater, Ferrara (IT); Gianni Vitale, Ferrara (IT)

Correspondence Address: BASELL USA INC., NEWTOWN SQUARE CENTER, 3801 WEST CHESTER PIKE, BLDG. B, NEWTOWN SQUARE, PA, 19703, US

(73) Assignee: Basell Poliolefine Italia s.r.l., Milan (IT)

(21) Appl. No.: 12/448,288

(22) PCT Filed: Dec. 10, 2007
(86) PCT No.: PCT/EP2007/063566

§ 371 Date: Jun. 16, 2009

Related U.S. Application Data
(60) Provisional application No. 60/876,448, filed on Dec. 21, 2006.

(30) Foreign Application Priority Data
Dec. 20, 2006 (EP) 06126598.9

(51) Int. Cl. C08F 4/52; B01J 27/138; B01J 27/135

(52) U.S. Cl. 526/119; 502/226; 502/227

(57) ABSTRACT

A catalyst component comprising Ti, Mg, Cl, and optionally OR^{I} groups in which R^{I} is a C1-C20 hydrocarbon group up to an amount such as to give a molar OR^{I}/Ti ratio lower than 0.5, characterized by the following properties:
surface area, determined by BET method, of lower than 80 m²/g,
a total porosity (P_{T}), measured by the mercury method, in the range of 0.60-1.50 cm³/g
a difference (P_{T}−P_{F}) of higher than 0.1 in which P_{T} is the total porosity and P_{F} is the porosity due to pore with radius equal to or less than 1 μm;
an amount of Ti in the catalyst component of less that 10% wt based on the total weight of catalyst component.

The said catalyst components show high morphological stability under the low molecular weight ethylene polymerization conditions while at the same time maintaining characteristics of high activity.

This application is the U.S. national phase of International Application PCT/EP2007/063566, filed Dec. 10, 2007, claiming priority to European Application 06126598.9 filed Dec. 20, 2006 and the benefit under 35 U.S.C. 119(e) of U.S. Provisional Application No. 60/876,448, filed Dec. 21, 2006; the disclosures of International Application PCT/EP2007/063566, European Application 06126598.9 and U.S. Provisional Application No. 60/876,448, each as filed, are incorporated herein by reference.

The present invention relates to catalyst components for the polymerization of olefins CH₂═CHR, wherein R is hydrogen or hydrocarbon radical having 1-12 carbon atoms. In particular, the invention relates to catalyst components suitable for the preparation of homopolymers and copolymers of ethylene and to the catalysts obtained therefrom. Furthermore, the invention relates also to ethylene homo or copolymers having high fluidity in the molten state and good morphological properties and to broad molecular weight ethylene polymers with spherical form and good morphology.

In particular the present invention relates to a solid catalyst component, comprising titanium magnesium and halogen, having a specific combination of physical and chemical characteristics.

Furthermore, the present invention relates to a process for preparing ethylene homopolymers and copolymers characterized by a high melt flow ratio expressed in terms of F/P ratio which is the ratio between the melt index measured with a 21.6 Kg load (melt index F) and the melt index measured with a 5 Kg load (melt index P), determined at 190° C. according to ASTM D-1238. Said ratio F/P is generally considered as an indication of the width of molecular weight distribution (MWD).

The MWD is a particularly important characteristic for ethylene (co) polymers, in that it affects both the rheological behavior and therefore the processability of the melt, and the final mechanical properties. Polyolefins having a broad MWD, particularly coupled with relatively high average molecular weights, are preferred in blow molding and high speed extrusion processing for example for the production of pipes. In fact, products characterized by broad MWD have superior mechanical properties that enable their use in applications where high stress resistance is required. The processing conditions for these polymers are peculiar and in fact under those conditions a narrow MWD product could not be processed because it would present failures due to melt fracture.

As it is difficult to have available catalysts offering the right pattern of molecular weight distribution and average molecular weight, one of the most common methods for preparing broad MWD polymers is the multi-step process based on the production of different molecular weight polymer fractions in each step, sequentially forming macromolecules with different chain length.

The control of the molecular weight obtained in each step can be carried out according to different methods, for example by varying the polymerization conditions or the catalyst system in each step, or by using a molecular weight regulator. Regulation with hydrogen is the preferred method either working in suspension or in gas phase. This latter kind of process is nowadays highly preferred due to both the high quality of the products obtained and to the low operative costs involved with it.

For a catalyst to perform in such a process, a critical step is that in which the low molecular weight fraction is prepared. In fact, one of important features that the catalyst should possess is the so called “hydrogen response”, that is the extent of capability to reduce the molecular weight of polymer produced in respect of increasing hydrogen concentrations. Higher hydrogen response means that a lower amount of hydrogen is required to produce a polymer with a certain molecular weight. In turn, this would normally involve also higher polymerization activity because the amount of hydrogen, which has a depressive effect on the catalyst activity, can be relatively lower.

In addition, due to the polymerization conditions and characteristics of the polymer produced in this step (intrinsically higher fragility), the catalyst/polymer system is often fragmented in very small particles that lowers the polymer bulk density and creates high amount of fines that makes difficult the operation of the plant particularly in the gas-phase polymerization. One of the ways to obviate to this problem would be that of performing the step of preparing the low molecular weight fraction after a first step in which the high molecular weight fraction is prepared. While this option may help in smoothing the plant operability, it often implies worsening of the final property of the product which turns out to be less homogeneous. So, it would be another important feature of the catalyst that of having a suitable morphology resistance under low molecular weight gas-phase polymerization conditions.

In EP-A-601525 are disclosed catalysts that, in some cases are able to give ethylene polymers with broad MWD (F/E ratios of 120 are reported). Such catalysts, obtained by a reaction between a Ti compound and a MgCl₂.EtOH adduct which has been subject to both physical and chemical dealcoholation, are characterized by a total porosity (mercury method) higher than 0.5 cm³/g, a surface area (BET method) lower than 70 m²/g. The pore distribution is also specific; in particular, in all the catalysts specifically disclosed at least 50% of the porosity is due to pores with radius higher than 0.125 μm. The cited patent application reported good performances in terms of morphological resistance (expressed by the bulk density) under conventional slurry polymerization conditions which however are not predictive of the behavior under low molecular weight polymerization conditions when a high amount of molecular weight regulator (hydrogen) is used. The applicant has indeed carried out the polymerization tests in those demanding conditions and proved that a substantial amount of catalyst broke down in the early polymerization stages giving rise to polymer fines and/or with irregular morphology thereby amounting to a very low final bulk density.

In WO00/78820 are disclosed catalysts able to give ethylene polymers with broad MWD characterized by a total porosity (mercury method) preferably in the range 0.38-0.9 cm³/g, and a surface area (BET method) preferably in the range 30-70 m²/g. The pore distribution is also specific; in particular, in all the catalysts specifically disclosed at least 45% of the porosity is due to pores with radius up to 0.1 μm. Preferably, the porosity due to pores with radius up to 1 μm differs for less than 15% with respect to the total porosity. This means that according to the cited patent application the porosity contribution of the pore fraction with pores higher than 1 μm should preferably be minor or absent. Also in this case the catalysts, notwithstanding the good performances under conventional polymerization conditions, show an unsatisfactory behavior under the demanding test conditions used by the applicant. This is also confirmed in the said document by the fact that when broad MWD polyethylene is prepared with two sequential polymerization stages, the low molecular weight fraction is always prepared in the second polymerization stage.

It is therefore still felt the need of a catalyst having high morphological stability under the low molecular weight ethylene polymerization conditions while at the same time maintaining characteristics of high activity.

The applicant has surprisingly found that catalyst components presenting the below combination of features are able to satisfy the needs. Accordingly, it is an object of the present invention a catalyst component comprising Ti, Mg, Cl, and optionally OR^{I} groups in which R^{I} is a C1-C20 hydrocarbon group up to an amount such as to give a molar OR^{I}/Ti ratio lower than 0.5, characterized by the following properties:
surface area, determined by BET method, of lower than 80 m²/g,
a total porosity (P_{T}), measured by the mercury method, in the range of 0.60-1.50 cm³/g
a difference (P_{T}−P_{F}) of higher than 0.1 in which P_{T} is the total porosity and P_{F} is the porosity due to pore with radius equal to, or less than, 1 μm;
an amount of Ti in the catalyst component of less that 10% wt based on the total weight of catalyst component.

Preferably the total porosity (P_{T}) ranges from 0.65 and 1.2 cm³/g, in particular between 0.70 and 0.90 cm³/g. The surface area measured by the BET method is preferably lower than 80 and in particular comprised between 25 and 70 m²/g. The porosity measured by the BET method is generally comprised between 0.1 and 0.7, preferably from 0.15 to 0.5 cm³/g.

As mentioned above, the porosity P_{F}, measured by mercury method and due to pores with radius equal to or less than 1 μm is such that the difference (P_{T}−P_{F}) is higher than 0.1, preferably ranging from 0.14-0.80 and more preferably ranging from 0.20 to 0.60.

In a preferred aspect, the catalyst component of the invention comprises a Ti compound having at least one Ti-halogen bond supported on a magnesium chloride which is preferably magnesium dichloride and more preferably magnesium dichloride in active form. In the context of the present application the term magnesium chloride means magnesium compounds having at least one magnesium chloride bond. As mentioned before, the catalyst component may also contain groups different from halogen, in any case in amounts lower than 0.5 mole for each mole of titanium and preferably lower than 0.3.

In the catalyst component of the invention the average pore radius value, for porosity due to pores up to 1 μm, is in the range from 600 to 1200 Å.

The particles of solid component have substantially spherical morphology and average diameter comprised between 5 and 150 μm, preferably from 20 to 100 μm and more preferably from 30 to 90 μm. As particles having substantially spherical morphology, those are meant wherein the ratio between the greater axis and the smaller axis is equal to or lower than 1.5 and preferably lower than 1.3.

The magnesium dichloride in the active form is characterized by X-ray spectra in which the most intense diffraction line which appears in the spectrum of the non active chloride (lattice distanced of 2.56 Å) is diminished in intensity and is broadened to such an extent that it becomes totally or partially merged with the reflection line falling at lattice distance (d) of 2.95 Å. When the merging is complete the single broad peak generated has the maximum of intensity which is shifted towards angles lower than those of the most intense line.

The solid catalyst components of the invention can also comprise an electron donor compound (internal donor), selected for example among ethers, esters, amines and ketones. Said compound is necessary when the component is used in the stereoregular (co)polymerization of olefins such as propylene, 1-butene, 4-methyl-pentene-1. In particular, the internal electron donor compound can be selected from the alkyl, cycloalkyl and aryl ether and esters of polycarboxylic acids, such as for example esters of phthalic and maleic acid, in particular n-butylphthalate, diisobutylphthalate, di-n-octylphthalate.

Other electron donor compounds advantageously used are the 1,3-diethers disclosed particularly in EP 361494, EP361493, and EP728769.

The electron donor compound is generally present in molar ratio with respect to the magnesium comprised between 1:4 and 1:20. In some cases it can also be present in lower amounts such as to give molar ratio magnesium/donor higher than 20.

The preferred titanium compounds have the formula Ti(OR^{II})ₙX_{y-n}, wherein n is a number comprised between 0 and 0.5 inclusive, y is the valence of titanium, R^{II} is an alkyl, cycloalkyl or aryl radical having 1-8 carbon atoms and X is halogen. In particular R^{II} can be ethyl, isopropyl, n-butyl, isobutyl, 2-ethylhexyl, n-octyl and phenyl, (benzyl); X is preferably chlorine.

If y is 4, n varies preferably from 0 to 0.02; if y is 3, n varies preferably from 0 to 0.015.

A method suitable for the preparation of spherical components mentioned above comprises a first step (a) in which a compound MgCl₂.m(R^{III}OH)tH₂O, wherein 0.3≦m≦1.7, t is from 0.01 to 0.6 and R^{III} is an alkyl, cycloalkyl or aryl radical having 1-12 carbon atoms is reacted with the said titanium compound of the formula Ti(OR^{II})ₙX_{y-n}, in which n, y, X and R^{II} have the same meaning defined above.

In this case MgCl₂.mR^{III}OH represents a precursor of Mg dihalide. These kind of compounds can generally be obtained by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034. Adducts having the desired final alcohol content can be obtained by directly using the selected amount of alcohol directly during the adduct preparation. However, if adducts with increased porosity are to be obtained, it is convenient to first prepare adducts with more than 1.7 moles of alcohol per mole of MgCl₂ and then subjecting them to a thermal and/or chemical dealcoholation process. The thermal dealcoholation process is carried out in nitrogen flow at temperatures comprised between 50 and 150° C. until the alcohol content is reduced to the value ranging from 0.3 to 1.7. A process of this type is described in EP-A-395083.

Generally these dealcoholated adducts are also characterized by a porosity (measured by mercury method) due to pores with radius due to pores with radius up to 0.1 μm ranging from 0.15 to 2.5 cm³/g preferably from 0.25 to 1.5 cm³/g.

In the reaction of step (a) the molar ratio Ti/Mg is stoichiometric or higher; preferably this ratio in higher than 3. Still more preferably a large excess of titanium compound is used. Preferred titanium compounds are titanium tetrahalides, in particular TiCl₄. The reaction with the Ti compound can be carried out by suspending the adduct in cold TiCl₄ (generally 0° C.); the mixture is heated up to 80-140° C. and kept at this temperature for 0.5-8 preferably from 0.5 to 3 hours. The excess of titanium compound can be separated at high temperatures by filtration or sedimentation and siphoning.

In the step (b) of the method, the solid product recovered from step (a) is subject to a thermal treatment carried out at temperatures higher than 100° C., preferably higher than 120° C., more preferably higher than 130° C., especially higher than 150° C. and most preferably higher than 160° C.

The thermal treatment can be carried out in several ways. According to one of them, the solid coming from step (a) is suspended in an inert diluent like a hydrocarbon and then subject to the heating while maintaining the system under stirring.

According to an alternative technique, the solid can be heated in a dry state by inserting it in a device having jacketed heated walls. While stirring can be provided by means of mechanical stirrers placed win said device it is preferred to cause stirring to take place by using rotating devices.

According to a still different embodiment the solid coming from (a) can be heated by subjecting it to a flow of hot inert gas such as nitrogen, preferably maintaining the solid under fluidization conditions.

The heating time is not fixed but may vary depending also on the other conditions such as the maximum temperature reached. It generally ranges from 0.1 to 10 hours more specifically from 0.5 to 6 hours. Usually, higher temperatures allow the heating time to be shorter while, on the opposite, lower temperatures may require longer reaction times. It is also possible to carry out the heating step (b) in the presence of additional compounds like for example SiCl₄ which may also constitute the liquid medium of the reaction step (b).

According to a still preferred embodiment the heating step (b) is carried out in the presence of an organometallic aluminum halide. Preferably, it is selected among organoaluminum compounds of formula R^{VII}_{z}AlX_{3-z} in which R^{VII} is a C₁-C₂₀ hydrocarbon group, z is from 0 to less than 3, preferably from 1 to 2 and X is halogen, preferably chlorine, iodine or bromine. Preferred organo-aluminum compounds are ethylaluminum dichloride (EADC) ethylaluminum didibromine, ethylaluminum diiodine, diethylaluminum chloride (DEAC), diethylaluminum bromine, diethylaluminum iodine and alkylaluminum sesquichlorides (Al₂Et₃Cl₃ EASC), iso-butylaluminumdichloride (IBADC), di-iso-butylaluminumchloride (DIBAC), iso-butylaluminumsesquichloride (IBASC), n-octylaluminumsesquichloride (NOASC). Also mixtures of the above mentioned organo-aluminum halides can be used.

The general conditions by which the thermal treatment is performed can be maintained substantially unaltered even in the presence of the organo-aluminum halides. However, it has been noted that the use of said compounds may allow a reduction of the time and/or temperature of the thermal treatment. In particular, when said aluminum-alkyl halide is present the thermal treatment can be carried out with excellent results at temperatures in the range of from 120° C. to 170° C. for period of time ranging from 0.5 to 6 hours.

Preferably, the said organo-aluminum halide can be used in molar ratio, with respect to the content of Ti atoms present in the solid coming from (a), ranging from 0.01 to 50, preferably 0.05 to 20 and more preferably of from 0.1 to 1.

It constitutes a preferred embodiment of the present invention preparing the catalyst component disclosed above by carrying out, after the step (a) and (b), a further step (c) in which the product coming from (b) is contacted with an electron donor compound preferably chosen among ethers, ketones, esters and silicon compounds. Preferably, said electron donor compound is chosen among diethers and diketones and more preferably among 1,3 diethers.

Preferred diethers are 9,9 dimethoxy fluorene and the 1,3 diethers mentioned EP 728769 among which 9,9-bis(methoxymethyl)fluorene is preferred. Among diketones, aliphatic diketones are preferred and among them acetylacetone being the most preferred. The contact is preferably carried out in an inert hydrocarbon as diluent at a temperature ranging from room temperature to the boiling temperature of the donor, generally from 40 to 150° C. and preferably from 50° C. to 140° C. The electron donor compound can be used in molar ratio with the Ti compound in the solid catalyst component coming from step (b) ranging from 5 to 0.01, preferably from 1 to 0.1 and more preferably from 0.8 to 0.1. The donor becomes fixed on the catalyst component in variable amounts which do not seem correlated with the effect on the morphological stability i.e, with the capability of the catalyst of producing high bulk density polymers even under demanding test conditions used by the applicant. In fact, the positive effect on the morphological stability is always present even when the amount of fixed donor is very low or, possibly absent. In particular, the treatment with the donor allow the catalyst to have an even more increased morphological stability evidenced by the fact that polymer with high bulk density are obtainable also by polymerizing ethylene in the presence of a high amount of hydrogen and by using triethylaluminum as cocatalyst which are known as extremely demanding conditions.

The catalyst components of the invention form catalysts, for the polymerization of alpha-olefins CH₂═CHR^{VIII} wherein R^{VIII} is hydrogen or a hydrocarbon radical having 1-12 carbon atoms by reaction with Al-alkyl compounds. In particular Al-trialkyl compounds, for example Al-trimethyl, Al-triethyl, Al-tri-n-butyl, Al-triisobutyl are preferred. The Al/Ti ratio is higher than 1 and is generally comprised between 5 and 800.

In case of the stereoregular polymerization of α-olefins such as for example propylene and 1-butene, an electron donor compound (external donor) which can be the same or different from the compound used as internal donor is also generally used in the preparation of the catalyst.

When the internal donor is an ester of a polycarboxylic acid, in particular a phthalate, the external donor is preferably selected from the silane compounds containing at least a Si—OR link, having the formula R^{IX}₄₋ₙSi(OR^{X})ₙ, wherein R^{IX} is an alkyl, cycloalkyl, aryl radical having 1-18 carbon atoms, R^{X} is an alkyl radical having 1-4 carbon atoms and n is a number comprised between 1 and 3. Examples of these silanes are methyl-cyclohexyl-dimethoxysilane, diphenyl-dimethoxysilane, methyl-t-butyl-dimethoxysilane, dicyclopentyldimethoxysilane.

It is possible to advantageously use also the 1,3 diethers having the previously described formula. In the case in which the internal donor is one of these diethers, the use of an external donor can be avoided, as the stereospecificity of the catalyst is already sufficiently high.

The spherical components of the invention and catalysts obtained therefrom find applications in the processes for the preparation of several types of olefin polymers.

As mentioned above, the catalysts of the invention are endowed with a particularly high morphological stability under high hydrogen concentration for the preparation of low molecular ethylene (co)polymer. The morphological stability of the catalyst of the invention may also be connected to their mechanical resistance. In fact, the catalysts of the invention show a good resistance when subject to impact tests. In particular, their resistance was tested by subjecting the solid catalyst components to flow under high velocity (55 m/sec) and to impact a metal plaque. Under these conditions, a certain amount of catalyst particles breaks and becomes fragmented in smaller particle thereby lowering the average particle size of the catalyst before testing and thus increasing the weight of the fractions having dimension lower than that of the original average dimension. In the catalyst of the invention this phenomena was highly reduced, with a very small amount of fine particles generated and with a limited reduction in average particle size after the test. It has therefore been observed that the catalysts of the invention are particularly suitable for use in cascade, or sequential polymerization processes, for the preparation of broad molecular weight ethylene polymers both in slurry and gas-phase. In general the catalyst can be used to prepare: high density ethylene polymers (HDPE, having a density higher than 0.940 g/cm³), comprising ethylene homopolymers and copolymers of ethylene with alpha-olefins having 3-12 carbon atoms; linear low density polyethylene's (LLDPE, having a density lower than 0.940 g/cm³) and very low density and ultra low density (VLDPE and ULDPE, having a density lower than 0.920 g/cm³, to 0.880 g/cm³ cc) consisting of copolymers of ethylene with one or more alpha-olefins having from 3 to 12 carbon atoms, having a mole content of units derived from the ethylene higher than 80%; elastomeric copolymers of ethylene and propylene and elastomeric terpolymers of ethylene and propylene with smaller proportions of a diene having a content by weight of units derived from the ethylene comprised between about 30 and 70%, isotactic polypropylenes and crystalline copolymers of propylene and ethylene and/or other alpha-olefins having a content of units derived from propylene higher than 85% by weight; shock resistant polymers of propylene obtained by sequential polymerization of propylene and mixtures of propylene with ethylene, containing up to 30% by weight of ethylene; copolymers of propylene and 1-butene having a number of units derived from 1-butene comprised between 10 and 40% by weight.

However, as previously indicated they are particularly suited for the preparation of broad MWD polymers and in particular of broad MWD ethylene homopolymers and copolymers containing up to 20% by moles of higher α-olefins such as propylene, 1-butene, 1-hexene, 1-octene.

One additional advantage of the catalyst described in the present application is that it can be used as such in the polymerization process by introducing it directly into the reactor without the need of pre-polymerizing it. This allows simplification of the plant set-up and simpler catalyst preparation process.

The main polymerization process in the presence of catalysts obtained from the catalytic components of the invention can be carried out according to known techniques either in liquid or gas phase using for example the known technique of the fluidized bed or under conditions wherein the polymer is mechanically stirred. However, the preferred process is carried out in the gas phase fluidized bed reactor. Whatever is the process involved, the catalyst described above in view of their good morphological particles stability can withstand to polymerization temperatures higher than the standard ones, that is higher than 80° C. and in particular in the range 85-100° C. As higher polymerization temperatures allow to simultaneously get higher yields and a more efficient heat removal due to the higher difference between polymerization temperature and the refrigerating fluid, it results that with the catalyst of the invention the productivity of the polymerization plant is greatly enhanced.

Examples of gas-phase processes wherein it is possible to use the spherical components of the invention are described in WO92/21706, U.S. Pat. No. 5,733,987 and WO93/03078. In this processes a pre-contacting step of the catalyst components, a pre-polymerization step and a gas phase polymerization step in one or more reactors in a series of fluidized or mechanically stirred bed are comprised even if as mentioned above, they are not strictly required with the catalyst of the invention.

Therefore, in the case that the polymerization takes place in gas-phase, the process of the invention is preferably carried out according to the following steps:
(a) contacting the catalyst components in the absence of polymerizable olefin or optionally in the presence of said olefin in amounts not greater than 20 g per gram of the solid component (A);
(b) gas-phase polymerization of ethylene or mixtures thereof with α-olefins CH₂═CHR, in which R is a hydrocarbon radical having 1-10 carbon atoms, in one or more fluidized or mechanically stirred bed reactors using the catalyst system coming from (a).

As mentioned above, in order to further broaden the MWD of the product, the process of the invention can be performed in two or more reactors working under different conditions and optionally by recycling, at least partially, the polymer which is formed in the second reactor to the first reactor. Usually, the two or more reactors work with different concentrations of molecular weight regulator or at different polymerization temperatures or both. Preferably, the polymerization is carried out in two or more steps operating with different concentrations of molecular weight regulator.

As already explained, one of the most interesting feature of the above described catalysts is the capability to produce ethylene polymers with low molecular weight, expressed by high melt index “E” value and good morphological properties expressed by high values of bulk density. In particular, the said ethylene polymers have Melt Index E higher than 50 and bulk densities higher than 0.35. Particularly preferred are those having MI″E″ higher than 70 and bulk density higher than 0.37 and most preferred are those with MI″E″ in the range 80400 and bulk density in the range 0.4-0.6. When these kind of polymers are produced in the low molecular weight polymerization step of a multi-step process, they allow obtaining ethylene polymers having at the same time broad MWD usually expressed by a melt flow ratio (F/P) value over 20, preferably over 25 and more preferably over 35, which is the ratio between the melt index measured with a 21.6 Kg load (melt index F) and the melt index measured with a 5 Kg load (melt index P), determined at 190° C. according to ASTM D-1238, bulk density over 0.44, preferably over 0.46 and preferably good homogeneity expressed by a number of gels (determined by the method set forth below) having diameter of higher than 0.2 mm of lower than 70 and preferably lower than 60. Moreover, preferably the films contain no gels with diameter higher than 0.5 mm. Once used in the production of films or pipes indeed, the polymers showed a very good processability while the extruded articles showed a very low number of gels. The polymer is obtained in form of spherical particles meaning that the ratio between the greater axis and the smaller axis is equal to, or lower than, 1.5 and preferably lower than 1.3.

The following examples are given in order to further describe and not to limit the present invention.

The properties are determined according to the following methods:
Porosity and surface area with nitrogen: are determined according to the B.E.T. method (apparatus used SORPTOMATIC 1900 by Carlo Erba).
Porosity and surface area with mercury:
The measure is carried out using a “Porosimeter 2000 series” by Carlo Erba.

The porosity is determined by absorption of mercury under pressure. For this determination use is made of a calibrated dilatometer (diameter 3 mm) CD₃ (Carlo Erba) connected to a reservoir of mercury and to a high-vacuum pump (1·10⁻² mbar). A weighed amount of sample is placed in the dilatometer. The apparatus is then placed under high vacuum (<0.1 mm Hg) and is maintained in these conditions for 20 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and then the mercury pressure is gradually increased with nitrogen up to 140 kg/cm². Under the effect of the pressure, the mercury enters the pores and the level goes down according to the porosity of the material.

The porosity (cm³/g), both total and that due to pores up to 1 μm, the pore distribution curve, and the average pore size are directly calculated from the integral pore distribution curve which is function of the volume reduction of the mercury and applied pressure values (all these data are provided and elaborated by the porosimeter associated computer which is equipped with a “MILESTONE 200/2.04” program by C. Erba.

| | |
|---|---|
| MIE flow index: | ASTM-D 1238 condition E |
| MIF flow index: | ASTM-D 1238 condition F |
| MIP flow Index | ASTM-D 1238 condition P |
| Bulk density: | DIN-53194 |
| Effective density: | ASTM-D 792 |

### Determination of Ti^{(red)}

0.5 g of the sample in powder form, are dissolved in 100 ml of HCl 2.7M in the presence of solid CO₂. The so obtained solution is then subject to a volumetric titration with a solution of FeNH₄(SO₄)₂.12H₂O 0.1N, in the presence of solid CO₂, using as indicator of the equivalence point NH₄SCN (25% water solution). The stoichiometric calculations based on the volume of the titration agent consumed give the weight amount of Ti³⁺ in the sample.

Determination of Mg, Ti₍ₜₒₜ₎ and Al: has been carried out via inductively coupled plasma emission spectroscopy (ICP) on a “I.C.P SPECTROMETER ARL Accuris”.

The sample was prepared by analytically weighting, in a “fluxy” platinum crucible”, 0.1÷03 g of catalyst and 3 gr of lithium metaborate/tetraborate 1/1 mixture. The crucible is placed on a weak Bunsen flame for the burning step and then after addition of some drops of KI solution inserted in a special apparatus “Claisse Fluxy” for the complete burning. The residue is collected with a 5% v/v HNO₃ solution and then analyzed via ICP at the following wavelength: Magnesium, 279.08 nm; Titanium, 368.52 nm; Aluminum, 394.40 nm.

Determination of Cl: has been carried out via potentiometric titration.
Determination of OR groups: via Gas-Chromatography analysis
Determination of gel number: 45 Kg of polymer are addictivated with Irgafox 168 (0.15 wt %), ZnO (0.15 wt. %), Zinc Stearate (0.05 wt. %), PPA-VITOW Z100 (0.03 wt. %) and are pelletized by a twin screw extruder WP (Werner & Pfliderer) ZSK 40 plus Gear pump plus under water pelletizer, keeping the temperature at 230° C. in all the sections at 38 Kg/h output. The product is then extruded into blown film, by using a grooved feed based extruder Dolci KRC 40, with barrel temperature profile of 220-225-225-220° C. and 230-230° C. at die zones. Output is 28 Kg/h at 50 rpm. Film is extruded with blow up ratio (BUR) of 4:1, and neck length of 7.5:1 at 20 micron thickness. The determination of the number of gels per m² is carried out by visually detecting the number of gels having size of the longest axis higher than 0.2 mm on a piece of the extruded film (25×7.5 cm size) which is projected by a projector, on the wall-chart with a magnified scale. The counting is made on 5 different pieces of the same film and a final number is given by the expression No=A/S where No is the number of gels per m², A is the number of gels counted on 5 film pieces and S is the overall surface in m² of the 5 films pieces examined.

### General Ethylene Polymerization Procedure (Procedure A)

A 4.5 liter stainless-steel autoclave equipped with a magnetic stirrer, temperature and pressure indicator, feeding line for hexane, ethylene, and hydrogen, was used and purified by fluxing pure nitrogen at 70° C. for 60 minutes. Then, a solution of 1550 cm³ of hexane containing 7.7 cm³ of 10% by wt/vol TiBAL/hexane was introduced at a temperature of 30° C. under nitrogen flow. In a separate 200 cm³ round bottom glass bottle were successively introduced, 50 cm³ of anhydrous hexane, 1 cm³ of 10% by wt/vol, TiBAL/hexane solution and 0.040÷0.070 g of the solid catalyst of table 1. They were mixed together, aged 10 minutes at room temperature and introduced under nitrogen flow into the reactor. The autoclave was closed, then the temperature was raised to 85° C., hydrogen (9 bars partial pressure) and ethylene (3.0 bars partial pressure) were added.

Under continuous stirring, the total pressure was maintained at 85° C. for 120 minutes by feeding ethylene. At the end the reactor was depressurised and the temperature was dropped to 30° C. The recovered polymer was dried at 70° C. under a nitrogen flow and analyzed.

### General Ethylene Polymerization Procedure (Procedure B)

The procedure is carried out under the same conditions disclosed for the procedure (A) with the only difference that triethylaluminum is used instead of triisobutylaluminum.

### EXAMPLES

### Preparation of the Spherical Support (Adduct MgCl₂/EtOH)

A magnesium chloride and alcohol adduct was prepared following the method described in example 2 of U.S. Pat. No. 4,399,054, but working at 2000 RPM instead of 10000 RPM.

The adduct containing about 3 mols of alcohol had an average size of about 70 μm with a dispersion range of about 45-100 μm.

### Example 1

### a) Preparation of the Intermediate Solid Component

A magnesium chloride and alcohol adduct containing about 3 mols of alcohol was prepared following the method described in example 2 of U.S. Pat. No. 4,399,054, but working at 2000 RPM instead of 10000 RPM. The adduct were subject to a thermal treatment, under nitrogen stream, over a temperature range of 50-150° C. until a weight content of 25% of alcohol was reached.

Into a 2 L four-necked round flask, purged with nitrogen, 1 L of TiCl₄ was introduced at 0° C. Then, at the same temperature, 70 g of a spherical MgCl₂/EtOH adduct containing 25% wt of ethanol and prepared as described above were added under stirring. The temperature was raised to 140° C. in 2 h and maintained for 60 min. Then, the stirring was discontinued, the solid product was allowed to settle and the supernatant liquid was siphoned off. The solid residue was then washed once with heptane at 80° C. and five times with hexane at 25° C. and dried under vacuum at 30° C. and analyzed.

### b) Thermal Treatment

Into a 250 cm3 four-necked round flask, purged with nitrogen, 100 cm3 of Isopar-L and 20.9 g of the intermediate solid component a) previously prepared, were introduced at 25° C. Under stirring, the temperature was raised to 170° C. in 45 minutes and maintained for 1 hour. Then, the temperature was decreased to 80° C., the stirring was discontinued, the solid product was allowed to settle for 30 minutes and the supernatant liquid was siphoned off.

The solid was washed with 100 cm3 of anhydrous heptane and three times at 25° C. Finally, the solid was dried under vacuum and analyzed. The analytical results are reported in table 1 while the polymerization results obtained by employing it in the ethylene polymerization procedure A described above are reported in table 2.

### Example 2

Into a 350 cm³ four-necked round flask, purged with nitrogen, 280 cm³ of Isopar-L and 19.8 g of the intermediate solid component a) of example 1, were introduced at 25° C. Under stirring, the temperature was raised to 180° C. in 60 minutes and maintained for 3 hours. Then, the temperature was decreased to 80° C., the stirring was discontinued, the solid product was allowed to settle for 30 minutes and the supernatant liquid was siphoned off. The analytical results are reported in table 1 while the polymerization results obtained by employing it in the ethylene polymerization procedure A described above are reported in table 2.

### Example 3

Into a 250 cm³ four-necked round flask, purged with nitrogen, 150 cm³ of Isopar-L and 4 cm³ of 20% wt/vol EASC/hexane solution (6.4 mg atoms of Al) were introduced at 25° C. The solution was stirred 10 minutes, then, at the same temperature, 15 g of the intermediate solid component a) of example 1, previously prepared, were added under stirring. The temperature was raised to 160° C. in 40 minutes and maintained for 1 hour. Then, the temperature was decreased to 80° C., the stirring was discontinued, the solid product was allowed to settle for 30 minutes and the supernatant liquid was siphoned off. The analytical results are reported in table 1 while the polymerization results obtained by employing it in the ethylene polymerization procedure A described above are reported in table 2.

### Example 4

Into a 250 cm³ four-necked round flask, purged with nitrogen, 75 cm³ of Isopar-L and 3.2 cm³ of 20% wt/vol EADC/hexane solution (5.04 mg atoms of Al) were introduced at 25° C. The solution was stirred 10 minutes, then, at the same temperature, 15 g of an intermediate solid as component a) of example 1, previously prepared, were added under stirring. The temperature was raised to 120° C. in 40 minutes and maintained for 5 hour. Then, the temperature was decreased to 80° C., the stirring was discontinued, the solid product was allowed to settle for 30 minutes and the supernatant liquid was siphoned off. The solid was washed three times with anhydrous hexane (100 cm³) at 25° C. and finally, the solid was dried under vacuum and analyzed. The analytical results are reported in table 1 while the polymerization results obtained by employing it in the ethylene polymerization procedure A described above are reported in table 2.

### Example 5

Into a 250 cm³ four-necked round flask, purged with nitrogen, 150 cm³ of Isopar-L and 4 cm³ of 20% wt/vol EASC/hexane solution (6.4 mg atoms of Al) were introduced at 25° C. The solution was stirred 10 minutes, then, at the same temperature, 15.2 g of an intermediate solid as component a) of example 1, previously prepared, were added under stirring. The temperature was raised to 180° C. in 60 minutes and maintained for 3 hour. Then, the temperature was decreased to 80° C., the stirring was discontinued, the solid product was allowed to settle for 30 minutes and the supernatant liquid was siphoned off. The solid was washed three times with anhydrous hexane (100 cm³) at 25° C. and finally, the solid was dried under vacuum and analyzed. The analytical results are reported in table 1 while the polymerization results obtained by employing it in the ethylene polymerization procedure A described above are reported in table 2.

### Example 6

Into a 250 cm³ four-necked round flask, purged with nitrogen, 150 cm³ of Isopar-L and 2.5 cm³ of 25.5% wt/vol EADC/hexane solution (5.0 mg atoms of Al) were introduced at 25° C. The solution was stirred 10 minutes, then, at the same temperature, 15.1 g of an intermediate solid as component a) of example 1, previously prepared, were added under stirring. The temperature was raised to 160° C. in 60 minutes and maintained for 1 hour. Then, the temperature was decreased to 80° C., the stirring was discontinued, the solid product was allowed to settle for 30 minutes and the supernatant liquid was siphoned off. The solid was washed three times with anhydrous hexane (100 cm³) at 25° C. and finally, the solid was dried under vacuum and analyzed. The analytical results are reported in table 1 while the polymerization results obtained by employing it in the ethylene polymerization procedure A described above are reported in table 2.

### Example 7

The catalyst component was prepared as described in example 6 with the only difference that the treatment was carried out at 130° C. for 5 hours. The analytical results are reported in table 1 while the polymerization results obtained by employing it in the ethylene polymerization procedure A described above are reported in table 2.

### Example 8

The catalyst component was prepared as described in example 7 with the only difference that ethylaluminum diiodide was used instead of EADC and that the treatment was carried out at 130° C. for 5 hours. The analytical results are reported in table 1 while the polymerization results obtained by employing it in the ethylene polymerization procedure A described above are reported in table 2.

### Example 9

The catalyst component was prepared as described in example 7 with the difference that diethylaluminum iodide was used instead of EADC in a molar ratio with Ti of 0.5 and that the treatment was carried out at 130° C. for 5 hours. The analytical results are reported in table 1 while the polymerization results obtained by employing it in the ethylene polymerization procedure A described above are reported in table 2.

### Example 10

The catalyst component was prepared as described in example 7 with the only difference that ethylaluminum dibromide was used instead of EADC and that the treatment was carried out at 130° C. for 5 hours. The analytical results are reported in table 1 while the polymerization results obtained by employing it in the ethylene polymerization procedure A described above are reported in table 2.

### Example 11

The catalyst component was prepared as described in example 7 with the difference that diethylaluminum bromide was used instead of EADC in a molar ratio with Ti of 0.5 and that the treatment was carried out at 130° C. for 5 hours. The analytical results are reported in table 1 while the polymerization results obtained by employing it in the ethylene polymerization procedure A described above are reported in table 2.

### Example 12

In a 500 mL four-necked round flask equipped with a mechanical stirrer and purged with nitrogen, 200 mL of anhydrous heptane and 2 g of the solid catalyst component obtained as disclosed in example 7 were charged at room temperature. At the same temperature, under stirring an amount of 9,9-dimethoxyfluorene to achieve a molar ED/Ti ratio of 0.25 was added dropwise. The temperature was raised to 50° C. and the mixture was stirred for 3 hours. Then, the stirring was discontinued, the solid product was allowed to settle and the supernatant liquid was siphoned off.

The solid was washed 3 times with anhydrous hexane (3×100 mL) at 25° C., recovered, dried under vacuum and analyzed. The final content of donor was 0.8%. The polymerization results obtained by employing it in the ethylene polymerization procedures A and B described above are reported in table 2.

### Example 13

The catalyst component was prepared as described in example 12 with the difference that acetylacetone was used instead of 9,9-dimethoxyfluorene. The final content of donor was 0.6%. The polymerization results obtained by employing it in the ethylene polymerization procedures A and B described above are reported in table 2.

### Example 14

The catalyst component was prepared as described in example 12 with the difference that 9,9-bis(methoxymethyl)fluorene was used instead of 9,9-dimethoxyfluorene and the ED/Ti molar ratio was 0.3. The final content of donor was 1.2%. The polymerization results obtained by employing it in the ethylene polymerization procedures A and B described above are reported in table 2.

### Example 15

The catalyst component was prepared as described in example 14 with the difference that the temperature of the treatment was 100° C. The final content of donor was 1.6%. The polymerization results obtained by employing it in the ethylene polymerization procedure B described above are reported in table 2.

### Comparative Example 1

The solid catalyst component prepared as described in example 1a was used in the ethylene polymerization procedures A and B described above and the results are reported in table 2.

### Example 16

### Preparation of a Broad MWD PE in a Cascade Polymerization Process

The polymerization process was carried out in a plant working continuously and basically equipped with a small reactor (pre-contacting pot) in which the catalyst components are mixed to form the catalytic system, a second vessel receiving the catalytic system formed in the previous step also equipped with mixing means, and two fluidized bed reactors (polymerization reactors) which are kept under fluidization conditions with propane.

The following reactants are fed to the pre-contacting pot:
the solid catalyst component prepared as described in example 4 but operating at 130° C. instead of 120° C.;
liquid propane as diluent
a solution of aluminum alkyl compound

The temperature is in the range of 10-60° C. and the total residence time (first and second vessels) ranges from 15 to 2 hrs. The so obtained catalytic system was then fed to the first gas-phase fluidized bed reactor operated at under the conditions reported in Table 3. The polymer produced in the first gas-phase reactor was then transferred to a second gas-phase reactor working under conditions reported in Table 3. The polymer discharged from the final reactor was first transferred to the steaming section and then dried at 70° C. under a nitrogen flow and weighted. The polymer properties are reported in table 4.

TABLE 1

| | | | | | | Porosity | |
|---|---|---|---|---|---|---|---|
| | | | | | (BET) Surface | (Hg method) | |
| | Mg | Ti | Al | EtOH | Area | P_{T} | P_{F} |
| Example | wt. % | wt. % | wt. % | wt. % | m²/g | cm³/g | cm³/g |
| 1 | 19.4 | 6.5 | — | 0.1 | 53.8 | 0.965 | 0.672 |
| 2 | 19.3 | 6.3 | — | 0.1 | 51.6 | 1.012 | 0.650 |
| 3 | 18.0 | 5.7 | 0.1 | 0.1 | 25.9 | 1.142 | 0.584 |
| 4 | 18.4 | 5.9 | 1.0 | 0.8 | 30.4 | 0.924 | 0.584 |
| 5 | 19.2 | 6.3 | 1.2 | <0.1 | 32.5 | 0.985 | 0.610 |
| 6 | 19.4 | 5.9 | 0.9 | 0.1 | 37.0 | 0.800 | 0.641 |
| 7 | 17.6 | 7.5 | 1.1 | 0.7 | 66.6 | 0.754 | 0.591 |
| 8 | 16.9 | 7.3 | 1.0 | 0.2 | 51.4 | 0.693 | 0.536 |
| 9 | 16.8 | 7.5 | 2.0 | 0.3 | 51.6 | 0.774 | 0.531 |
| 10 | 17.0 | 7.2 | 1.2 | 0.3 | 56.5 | 0.771 | 0.627 |
| 11 | 17.1 | 7.0 | 1.9 | 0.7 | 48.2 | 0.786 | 0.621 |
| Comp. 1 | 19.0 | 6.4 | — | 1.4 | 58.7 | 0.703 | 0.643 |

TABLE 2

| | Pol. | Yield | MI E | BDP | |
|---|---|---|---|---|---|
| Example | Procedure | KgPE/gcat | dg/min | g/cm3 | morphology |
| 1 | A | 3.4 | 93 | 0.378 | spherical |
| 2 | A | 3.2 | 58 | 0.396 | spherical |
| 3 | A | 3.9 | 93 | 0.395 | spherical |
| 4 | A | 4.6 | 150 | 0.360 | spherical |
| 5 | A | 3.2 | 100 | 0.398 | spherical |
| 6 | A | 4.2 | 92 | 0.406 | spherical |
| 7 | A | 4.8 | 96.2 | 0.385 | Spherical |
| 8 | A | 3.4 | 93.6 | 0.403 | Spherical |
| 9 | A | 4.6 | 110 | 0.393 | Spherical |
| 10 | A | 4.1 | 92 | 0.400 | Spherical |
| 11 | A | 5.9 | 98 | 0.385 | Spherical |
| 12 | A | 4 | 78.2 | 0.435 | Spherical |
| | B | 4.4 | 133 | 0.300 | Spherical/broken |
| 13 | A | 3.5 | 69 | 0.425 | Spherical |
| | B | 4.6 | 79 | 0.303 | Spherical/broken |
| 14 | A | 4.1 | 80 | 0.421 | Spherical |
| | B | 5.2 | 136 | 0.330 | Spherical/broken |
| 15 | B | 4.0 | 200 | 0.360 | Spherical |
| Comp. 1 | A | 13.6 | 113 | 0.269 | Broken |

TABLE 3
Pre-contacting

| 1^{st} Vessel | | | | | 2^{nd} vessel | |
|---|---|---|---|---|---|---|
| | | | Average | | Average | |
| | | | Residence | | Residence | |
| Cat. | AlR₃ | AlR₃/Cat. | Time | T | Time | T° |
| (g/h) | type | (g/g) | (min) | (° C.) | (min) | (° C.) |
| 10 | TiBA | 4 | 13 | 50 | 60 | 50 |

First Fluidized bed reactor

| | | Average | | | |
|---|---|---|---|---|---|
| | | Residence | | | |
| C₂⁻ | H₂/C₂⁻ | Time | P | T | Yield |
| (mol %) | (mol | (hr) | barg | (° C.) | (Kg/h) |
| 9.7 | 4.06 | 2.0 | 24 | 75 | 60 |

Second Fluidized-bed reactor

| Average | | | | | | |
|---|---|---|---|---|---|---|
| Residence | | | | | | |
| Time | T | P | C₂H₄ | H₂/C₂⁻ | C6−/C2+C6− | Yield |
| (hr) | (° C.) | barg | (mol %) | (mol) | (mol) | (Kg/h) |
| 2.2 | 75 | 24 | 5.2 | 0.056 | 0.071 | 116 |

TABLE 4
Final polymer

| | |
|---|---|
| MIP (g/10′) | 0.27 |
| MIF/MIP | 29.3 |
| Bulk Density (Kg/dm³) | 0.472 |
| Gel Number/m² | |
| >0.2 mm | 40 |
| 0.5 ÷ 0.7 mm | 0 |
| 0.7 ÷ 1.5 mm | 0 |
| >1.5 mm | 0 |

1-13. (canceled)

14. Catalyst components for the polymerization of olefins comprising Ti, Mg, Cl, and optionally, OR^{I} groups wherein R^{I} is a C1-C20 hydrocarbon group present in an amount to give a molar OR^{I}/Ti ratio lower than 0.5, characterized by the following properties:
a surface area, determined by BET method, lower than 80 m²/g;
a total porosity (P_{T}), measured by the mercury method, in the range of 0.60-1.50 cm³/g;
a difference (P_{T}−P_{F}) higher than 0.1 wherein P_{F} is a porosity due to pores with radius equal to or less than 1 μm; and
an amount of Ti in the catalyst component less that 10 wt % based on the total weight of catalyst component.

15. The solid catalyst component according to claim 14 wherein the total porosity (P_{T}) is in the range of 0.65-1.2 cm³/g.

16. The solid catalyst component according to claim 14 wherein the difference (P_{T}−P_{F}) is in the range of 0.14-0.80.

17. The solid catalyst component according to claim 14 comprising a Ti compound having at least one Ti-halogen bond supported on magnesium chloride.

18. A process for the preparation of the catalyst component according to claim 14 comprising a first step (a) wherein a compound MgCl₂.m(R^{III}OH)ₜH₂O, wherein 0.3≦m≦1.7, t is from 0.01 to 0.6 and R^{III} is an alkyl, cycloalkyl or aryl radical having 1-12 carbon atoms, is reacted with a titanium compound of the formula Ti(OR^{II})ₙX_{y-n}, wherein n is between 0 and 0.5, y is the valence of titanium, X is halogen and R^{IV} is an alkyl radical having 1-8 carbon atoms; and a second step (b) wherein a solid product of step (a) is subject to a thermal treatment carried out at temperatures higher than 100° C.

19. The process according to claim 18 wherein the thermal treatment is carried out at temperatures higher than 120° C.

20. The process according to claim 19 wherein the thermal treatment is carried out in the presence of an organometallic aluminum halide.

21. The process of claim 18 further comprising a step (c) wherein a product of step (b) is contacted with an electron donor compound.

22. A process comprising (co)polymerizing ethylene in the presence of a catalyst system comprising the product of a reaction of the solid catalyst component according to claim 1 and an alkylaluminum compound.

23. The process of claim 21 carried out in gas-phase.

24. The process of claim 22 carried out in two or more reactors working under different concentrations of molecular weight regulator.
